(19) United States
(12) Patent Application Publication
(10) Pub. No.: US 2009/0327043 A1
(43) Pub. Date: Dec. 31, 2009

(54) Method And System Of Ranking A Document

(76) Inventor: Maheshinder Singh Sekhon, Franklin, IN (US)

Correspondence Address: BAY AREA INTELLECTUAL PROPERTY GROUP, LLC, PO BOX 210459, SAN FRANCISCO, CA, 94121-0459, US

(21) Appl. No.: 12/431,977

(22) Filed: Apr. 29, 2009

Related U.S. Application Data
(60) Provisional application No. 61/075,634, filed on Jun. 25, 2008.

(51) Int. Cl. G06Q 10/00

(52) U.S. Cl. 705/10

(57) ABSTRACT

A method and system of ranking a document includes submitting an importance rank for the document by a first plurality of users for assigning a document importance rank to the document. A second plurality of users votes on the document for determining a popularity rank of the document where the popularity rank indicates a popularity of the document and the popularity rank at least, in part, determines a popularity index for the document. N number of users of the first plurality of users that submitted the N highest importance ranks receives incentives when the document has the popularity rank greater than the popularity index.

### CROSS-REFERENCE TO RELATED APPLICATIONS

The present Utility patent application claims priority benefit of the U.S. provisional application for patent Ser. No. 61/075,634 filed on Jun. 25, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to databases. More particularly, the invention relates to a technique of obtaining an un-biased, subjective analysis of a document from a user on the World Wide Web or any other database.

### BACKGROUND OF THE INVENTION

Given that the Internet today has well over 100 billion documents of varying quality, it is almost impossible to gather a large enough team of people to independently review and analyze all of the content in an un-biased manner. It is both time-prohibitive and cost-prohibitive. This is the primary reason that almost all search engines use different computer algorithms to programmatically assess the quality of a document. Algorithms are fast, cheap and, above all, eliminate bias since people do not directly make a value judgment on the document quality. The overwhelming success of Google is a good example of this approach. The main limitation of this approach is that, no matter how good a computer algorithm is, it can never come close to the analysis done by a person in assessing the intrinsic value of a document. However, until the early 2000s, it would have been impossible to engage millions of global everyday end-users in evaluating billions of documents as the technology (e.g., broadband, cheaper hardware, internet access, etc.) was not there. Even as the technology to engage people on such a massive scale exists today, what lacks is the motivation or incentive to engage people in the process of content evaluation.

Some existing solutions have incentive schemes that pay people to review and/or submit content. However, these and other sites have not found a way to address the issue of bias that creeps up in the evaluation process. For example, digg.com was once a very popular site, and some argue it still is; however, recently this site has been “taken over” by a few individuals called “top diggers”, where only posts from these “top diggers” show up on top. What has plagued all search engines so far is that ultimately they end up introducing bias into their search results.

In view of the foregoing, there is a need for improved techniques for providing an un-biased, subjective analysis of content that provides incentives to participants.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart illustrating an exemplary process of updating the importance rank of documents in a database by a user, in accordance with an embodiment of the present invention;

FIG. 2 is a flowchart illustrating an exemplary process of voting on documents in a database to influence the popularity of these documents, in accordance with an embodiment of the present invention;

FIG. 3 is a flowchart illustrating an exemplary process of determining winning users from a “Contest database”, in accordance with an embodiment of the present invention; and

FIG. 4 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method and system of ranking a document is presented.

In one embodiment a method of ranking a document is presented. The method includes steps for submitting an importance rank for the document for assigning a document importance rank to the document, steps for voting on the document for determining a popularity rank and at least, in part, determining a popularity index for the document and steps for receiving incentives by N number of users that submitted the N highest importance ranks for the document.

In another embodiment a method of ranking a document is presented. The method includes steps of submitting an importance rank for the document by a first plurality of users for assigning a document importance rank to the document. A second plurality of users votes on the document for determining a popularity rank of the document where the popularity rank indicate a popularity of the document and the popularity rank at least, in part, determines a popularity index for the document. N number of users of the first plurality of users that submitted the N highest importance ranks receives incentives when the document has the popularity rank greater than the popularity index.

In another embodiment a system of ranking a document is presented. The system includes means for submitting an importance rank for the document for assigning a document importance rank to the document, means for voting on the document for determining a popularity rank and at least, in part, determining a popularity index for the document and means for receiving incentives by N number of users that submitted the N highest importance ranks for the document.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention invite individuals to judge the quality of documents in large databases such as, but not limited to, the World Wide Web and invite users to vote on the quality of documents. Preferred embodiments provide a system of rewarding individuals who accurately evaluate document quality by introducing cash and other rewards as an incentive to engage these individuals in ranking contents in large databases. Preferred embodiments also generally eliminate bias in this ranking by validating all of the reviews in a voting contest. If a user gives a high rating to content and this high rating is not backed or validated by popular vote, this rating is most likely a biased evaluation. In preferred embodiments, as a user wins more and more of these contests, their credibility rating increases over time. The reward system in preferred embodiments will encourage and engage more and more individuals to contribute to a mass subjective analysis of the database. When used on the World Wide Web, such a subjective analysis will greatly enhance a search engine's ability to narrow its results to high quality and relevant information. Preferred embodiments may be implemented on the Internet or on an intranet.

In preferred embodiments a method assigns two ranks to documents on the World Wide Web or in any other database. The first rank is an importance rank that is assigned by a user. The other rank is a measure of a document's popularity and is calculated based on votes by a plurality of users. In preferred embodiments, the method obtains multiple users, some of whom assign importance ranks to documents and some of whom vote to influence the popularity rank of documents. In some embodiments users who wish to assign importance ranks to documents may have to register as a content evaluator, and other embodiments may enable all users to assign importance ranks. In preferred embodiments a computer-implemented program is used to identify the users who have assigned a higher importance rank to a document that is later voted as popular. These users are then rewarded to encourage these users to analyze more documents in an un-biased manner, thereby enhancing a search engine's ability to narrow its results to documents that have been carefully evaluated by experts and other people.

Preferred embodiments of the present invention provide a contest on a website that rewards users who identify quality content in a large database such as, but not limited to, the World Wide Web. The contest in these preferred embodiments comprises three processes, illustrated by way of example in the following figures.

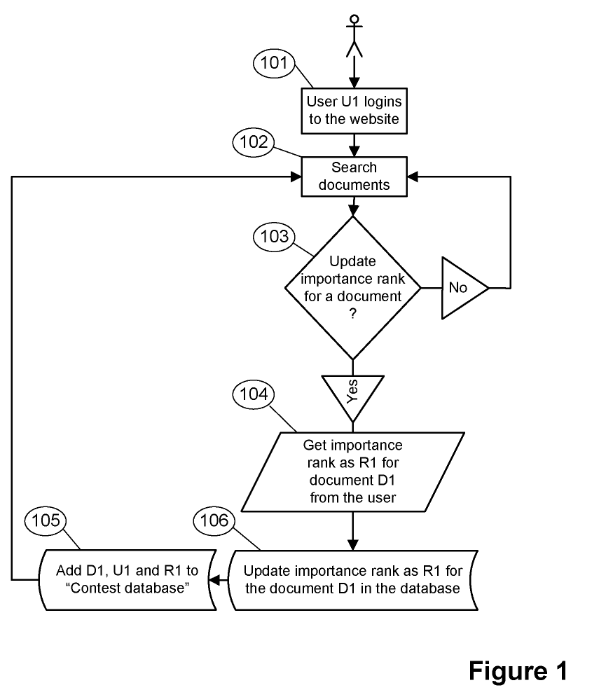

FIG. 1 is a flow chart illustrating an exemplary process of updating the importance rank of documents in a database by a user, in accordance with an embodiment of the present invention. The present embodiment comprises a website that enables the user to search and review documents in the database. The database may be a large database such as, but not limited to, the World Wide Web or a smaller database. Furthermore, the database may be located on a large network such as, but not limited to, the Internet or a smaller network such as, but not limited to, an intranet. In step 101 the user logs in to the website. In some embodiments this log in step may also verify the user as an individual who is registered as a content evaluator and retrieve a credibility rating for the user. The credibility rating for a user is based on many factors including, but not limited to, past history of winning contests, activity level, etc. In step 102 of the present embodiment, the user searches documents in the database.

If a user wishes, they can update an importance rank for any document that they believe is high quality. In step 103 it is determined if the user wishes to update the importance rank of a document. If not, the process returns to step 102 where the user can continue to search documents. If the user wishes to update the importance rank of the document, the process continues to step 104, where the current importance rank for the document is retrieved from the user as R1. In the present embodiment, a numerical range is presented to the user from which the user may choose the importance rank where a higher rank signifies higher quality and relevance. The maximum value of the importance rank a user can assign depends on the credibility rating of the user. Alternate embodiments may be implemented without the use of credibility ratings where all users may rank the documents using the same range. In other alternate embodiments, the user may be presented with various different means for changing the importance rank of a document. For example, without limitation, the user may be asked to place a group of documents in order of relevance, the user may be asked to choose from relevance labels such as, but not limited to, not relevant, somewhat relevant, relevant, and very relevant, the user may be asked to assign a relevance percentage out of 100 percent etc. Then, in step 106, the importance rank of the document is updated as R1 in the database. In alternate embodiments, the importance rank may be a cumulative score that totals or averages the importance ranks assigned by multiple users.

In the present embodiment after the user assigns an importance rank to a document, the system creates an entry for that user in a “Contest database” in step 105 to automatically enter the user in the contest. An entry is created for the user each time the user assigns an importance rank to a document. A user may rank as much content in the database as he likes. The process then returns to step 102.

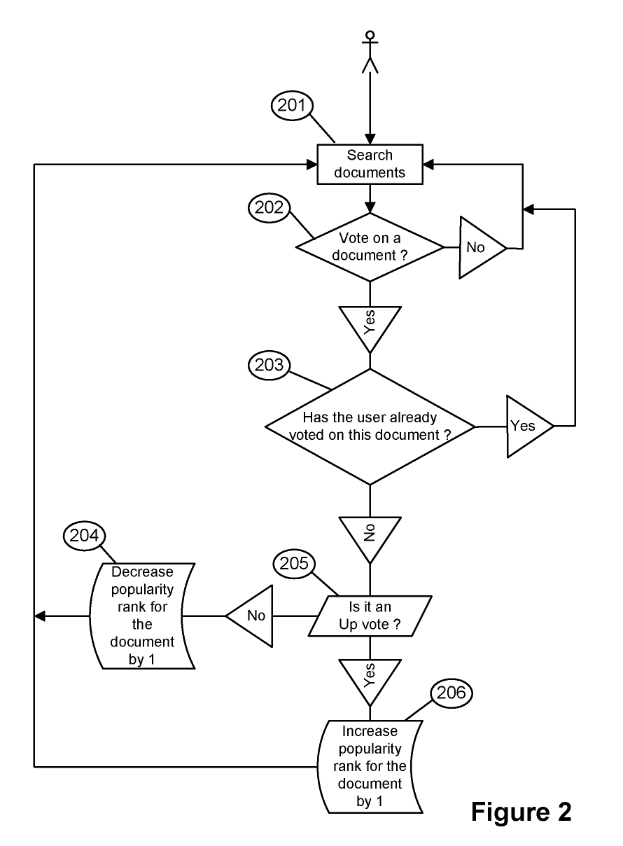

FIG. 2 is a flowchart illustrating an exemplary process of voting on documents in a database to influence the popularity of these documents, in accordance with an embodiment of the present invention. In the present embodiment, the user searches documents in the database in step 201. In step 202 it is determined if the user wishes to vote on a document. If not, the process returns to step 201, where the user can continue to search documents in the database. If the user wishes to vote on a document, it is determined in step 203 if the user has already voted on this document. In the present embodiment, a user can vote only once, up or down, on a document although they can vote on as many documents as they like. In alternate embodiments, users may be able to vote on documents multiple times. In the present embodiment, if the user has already voted on the document, the process returns to step 201, and if not, it is determined if the vote is an up vote in step 205. If the vote is not an up vote, the popularity rank of the document is decreased by one in step 204 and the process returns to step 201. If the vote is an up vote, the popularity rank of the document is increased by one in step 206 and the process returns to step 201. As more and more users vote on the content, the most popular and relevant content will rise to the top. In alternate embodiments various different methods for voting on documents may be used. For example, without limitation, users voting on documents may be able to give the document a rating, such as, but not limited to, a rating out of five stars, from one to ten, etc. where these ratings are averaged for all users who vote on the document.

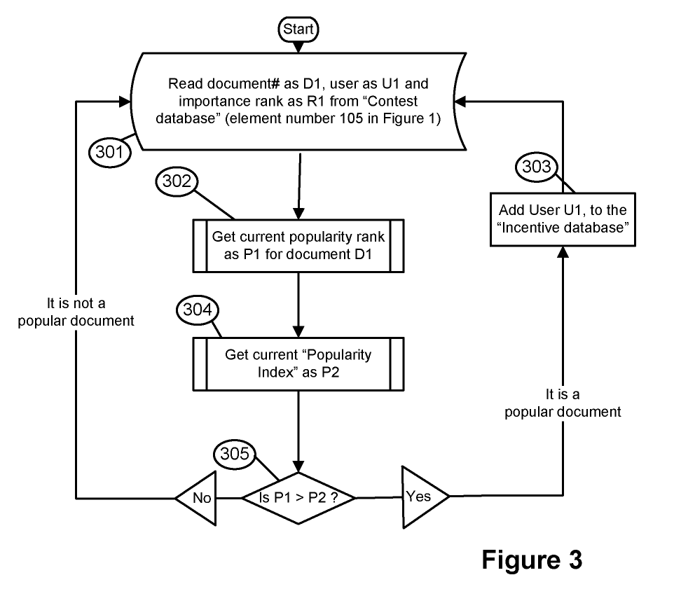

FIG. 3 is a flowchart illustrating an exemplary process of determining winning users from a “Contest database”, in accordance with an embodiment of the present invention. In the present embodiment, the system compares the current popularity of every document in the database against a “Popularity Index” to determine which documents are considered popular. The “Popularity Index” is a variable value that is calculated based on factors such as, but not limited to, website traffic, user activity, average popularity rank, etc. In step 301a user who has been entered into the “Contest database” by updating the importance rank of a document is retrieved along with the document that the user ranked and the importance rank assigned to the document by the user. In step 302 the current popularity rank for the document as determined by voting is retrieved. The current “Popularity Index” is retrieved in step 304. It is determined in step 305 if the popularity rank of the document is greater than the current “Popularity Index”. If the current popularity rank of a document is greater than the current “Popularity Index”, the document is determined to be popular and the user is entered into an “Incentive database” in step 303 to be rewarded. As there could be more than one user who had assigned a higher importance rank to a popular document, the system will reward the top ‘n’ number of users. The number of users to be rewarded will be based on various factors including but not limited to past history of winning, the amount of money available in the incentive program, the order by date in which they ranked, etc. If the current popularity rank is less than the current “Popularity Index”, the document is determined to be not popular and the process returns to step 301. Users in the “Incentive database” are considered to be winners and may be rewarded in various ways; for example, without limitation, users may be rewarded financially, with material awards, etc. In the present embodiment, users in the “Incentive database” also receive a higher credibility rating for identifying a popular document, and users with higher credibility ratings are able to assign higher importance ratings.

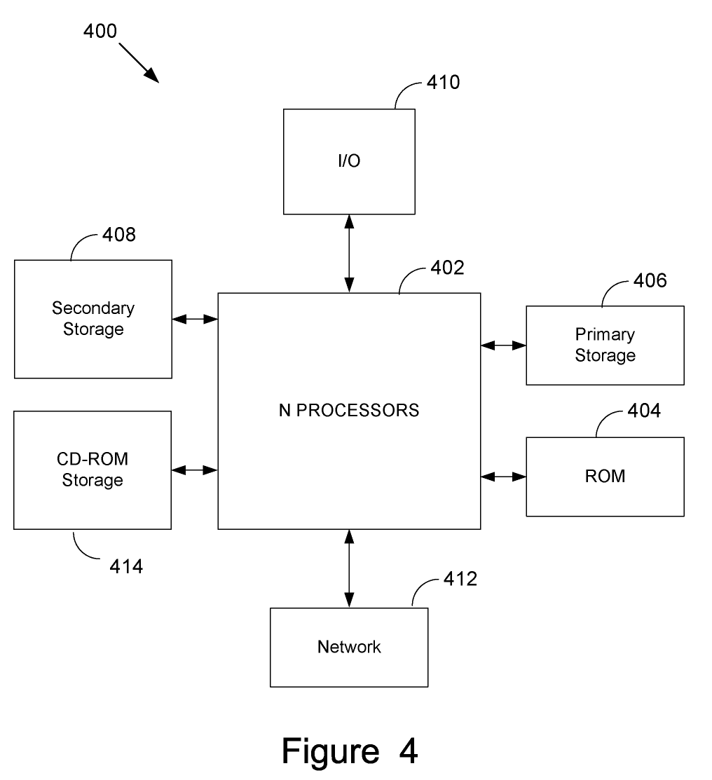

FIG. 4 illustrates a typical computer system that, when appropriately configured or designed, can serve as a computer system in which the invention may be embodied. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU. CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection as shown generally at 412, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC § 112 (6) it is intended that the corresponding means for and/or steps for carrying out the claimed function also include those embodiments, and equivalents, as contemplated above that implement at least some novel aspects and objects of the present invention in the jurisdiction of the USA. For example, application servers used above may be located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing an unbiased analysis of a document from a user of a database according to the present invention will be apparent to those skilled in the art. The invention has been described above by way of illustration, and the specific embodiments disclosed are not intended to limit the invention to the particular forms disclosed. For example, the particular implementation of the method may vary depending upon the particular type of system used. The systems described in the foregoing were directed to website-based implementations; however, similar techniques are to implement document-rating methods using systems other than websites such as, but not limited to, software programs. Non website-based implementations of the present invention are contemplated as within the scope of the present invention. The invention is thus to cover all modifications, equivalents, and alternatives falling within the spirit and scope of the following claims.

What is claimed is:

1. A method of ranking a document, the method comprising:
steps for submitting an importance rank for the document for assigning a document importance rank to the document;
steps for voting on the document for determining a popularity rank and at least, in part, determining a popularity index for the document; and
steps for receiving incentives by N number of users that submitted the N highest importance ranks for the document.

2. The method as recited in claim 1, wherein said importance rank is within an assigned range.

3. The method as recited in claim 2, wherein said N number of users receiving incentives receive a larger assigned range for submitting importance ranks of additional documents.

4. The method as recited in claim 1, wherein said incentives are financial or material rewards.

5. A method of ranking a document, the method comprising steps of:
submitting an importance rank for the document by a first plurality of users for assigning a document importance rank to the document;
voting on the document by a second plurality of users for determining a popularity rank of the document where said popularity rank indicates a popularity of the document and said popularity rank at least, in part, determines a popularity index for the document; and
receiving incentives by N number of users of said first plurality of users that submitted the N highest importance ranks for the document when the document has said popularity rank greater than said popularity index.

6. The method as recited in claim 5, wherein said first plurality of users subjectively analyzes the document.

7. The method as recited in claim 5, wherein said submitted importance ranks are stored in a database along with identities of said first plurality of users.

8. The method as recited in claim 7, wherein said receiving is a result of searching said database.

9. The method as recited in claim 5, wherein each of said first plurality of users uses an assigned range of ranking for submitting said importance rank.

10. The method as recited in claim 9, wherein said N number of users receiving incentives receive a larger assigned range for submitting importance ranks of additional documents.

11. The method as recited in claim 9, wherein said assigned range is a numerical range.

12. The method as recited in claim 11, wherein a higher numerical value of said numerical range indicates a higher quality and relevance.

13. The method as recited in claim 5, wherein a positive vote increments said popularity rank and a negative vote decrements said popularity rank.

14. The method as recited in claim 5, wherein each of said second plurality of users is restricted to one vote for the document.

15. The method as recited in claim 5, wherein said incentives are financial rewards.

16. The method as recited in claim 5, wherein said incentives are material rewards.

17. A system of ranking a document, the system comprising:
means for submitting an importance rank for the document for assigning a document importance rank to the document;
means for voting on the document for determining a popularity rank and at least, in part, determining a popularity index for the document; and
means for receiving incentives by N number of users that submitted the N highest importance ranks for the document.

18. The system as recited in claim 17, wherein said importance rank is within an assigned range.

19. The system as recited in claim 18, wherein said N number of users receiving incentives receive a larger assigned range for submitting importance ranks of additional documents.

20. The system as recited in claim 17, wherein said incentives are financial or material rewards.
